(19) United States
(12) Patent Application Publication
(10) Pub. No.: US 2017/0359573 A1
(43) Pub. Date: Dec. 14, 2017

(54) METHOD AND APPARATUS FOR CAMERA CALIBRATION USING LIGHT SOURCE

(71) Applicant: SAMSUNG SDS CO., LTD., Seoul (KR)

(72) Inventors: Ju Dong KIM, Seoul (KR); Soon Yong JUNG, Seoul (KR); Joon Seok LEE, Seoul (KR); Jae Seon PARK, Seoul (KR); Ji Seon JANG, Seoul (KR); Ji Eun SONG, Seoul (KR)

(73) Assignee: SAMSUNG SDS CO., LTD., Seoul, KOREA, REPUBLIC OF;

(21) Appl. No.: 15/617,670

(22) Filed: Jun. 8, 2017

(30) Foreign Application Priority Data
Jun. 8, 2016 (KR) 10-2016-0071261

(51) Int. Cl. H04N 17/00; G06T 7/80; H04N 5/225

(52) U.S. Cl. CPC H04N 17/002; H04N 5/2256; G06T 7/80; G06T 2207/30204

(57) ABSTRACT

Apparatuses for camera calibration using a light source are provided, one of apparatus comprises, a n-light sources (n is 3 or more) which can be mounted on the camera, an actual coordinate computation processing unit which irradiates light to an image pickup surface being captured by the camera through the n-light sources to capture an image of an n-sided polygon made up of n-light spots formed on the image pickup surface, and analyses a degree of distortion on the n-sided screen to obtain n or more coordinate pairs obtained by matching the coordinates on the screen and the coordinates on an actual space and a calibration computation processing unit which receives the n or more coordinate pairs as input to convert a two-dimensional coordinate on the screen into a three-dimensional coordinate on the actual space.

This application claims priority from Korean Patent Application No. 10-2016-0071261 filed on Jun. 8, 2016 in the Korean Intellectual Property Office, the disclosure of which is incorporated herein by reference in its entirety.

### BACKGROUND OF THE INVENTION

### 1. Field of the Invention

The present invention relates to a method and apparatus for automatically performing calibration of an image analysis camera, using a light source. More specifically, the present invention relates to a method for detecting light spots produced by a light source mounted on a camera in a region in which the camera captures an image when the light source irradiates the region with the light source, analyzing the coordinates of a figure made up of the light spots in the captured image, and obtaining a transformation matrix using the coordinates, and an apparatus for executing the method.

### 2. Description of the Related Art

The camera calibration in the image analysis is a process of computing a transformation matrix for acquiring the actual size and position information of an object detected in the image. Although the actual object exists on a three-dimensional space, since the object in the image exists in a two-dimensional screen, a distortion naturally occurs. That is, there is a distortion in which a near object on the screen looks large and a distant object looks small.

Even though the distortion is corrected and displayed small on the screen, as long as it is possible to obtain the actual size information of the object displayed small, that is, the length, width, and height on the three-dimensional space, much information can be obtained through the image analysis. To this end, there is a need for a transformation matrix capable of transforming the 2D coordinates of the image into the actual 3D coordinates. That is, there is a need for a transformation matrix capable of converting the (x, y) coordinates of the image into the actual (X, Y, and Z).

Conventionally, in order to obtain such a transformation matrix, the camera calibration has been performed by capturing an image of a reference object having already known length and width with a camera, and by analyzing the coordinates of the reference object in the image. In the process, although there has been a help of the calibration program, manual works such setting of the coordinates of the reference object while locating the reference object at a location to be captured have not been completely eliminated.

For example, the invention of KR 1545633 B1 titled “Calibration method and system of car stereo camera” of the Electronic Components Research Institute, in order to execute the calibration of the car stereo camera, a calibration marker capable of being attachable to and detachable from a bonnet of a car is used. In this way, conventionally, there was a step of consuming the time and cost, such as a need to manually install the calibration markers each time calibration is performed.

If the camera to be used is a camera with the PTZ function (Pan, Tilt, and Zoom), it is necessary to execute the camera calibration each time after the PTZ operation so that it is possible to analyze the image and obtain the information of the object. In addition, even if there is no camera with a PTZ function, if the position of the camera is distorted due to external factors, there is an inconvenience in which it is necessary to manually perform the camera calibration each time.

There is a need for a method for enabling automatic calibration of camera even without the manual work.

### SUMMARY OF THE INVENTION

An aspect of the present invention provides a method and an apparatus for automatically executing a camera calibration using a light source.

Another aspect of the present invention provides a method and an apparatus for automatically executing a camera calibration using a laser.

The aspects of the present invention are not limited to those mentioned above and another aspect which has not been mentioned can be clearly understood by ordinary engineers from the description below.

According to some embodiments of the present invention, it is possible to analyze the image captured using the laser point irradiated by a laser diode-mounted on a camera. That is, in the captured image, the camera calibration can be automatically performed, using the distance and the angle between the respective laser points. Also, by periodically performing the camera calibration, it is possible to keep the transformation matrix in the latest state, regardless of a change in camera position. This enables improvement in the efficiency of image analysis, and reduction in the cost and time consumption compared with the conventional camera calibration method.

The effects of the present invention are not limited to the aforementioned effects, and other effects that have not been mentioned can be clearly understood by ordinary technicians from the following description.

### BRIEF DESCRIPTION OF THE DRAWINGS

The above and other aspects and features of the present invention will become more apparent by describing in detail exemplary embodiments thereof with reference to the attached drawings, in which:

FIG. 1 is an exemplary view illustrating a conventional camera calibration method;

FIG. 2 is a flowchart of a conventional camera calibration method.

FIG. 3a is a front view and a side view illustrating laser diode-mounted camera according to an embodiment of the present invention;

FIG. 3b is an exemplary view illustrating a process of extracting a laser point irradiated by laser diode in the laser diode-mounted camera according to an embodiment of the present invention;

FIG. 4 is an exemplary view illustrating a case where a camera on which a laser diode according to an embodiment of the present invention is mounted captures an image from above in the vertical direction;

FIGS. 5a to 5c are exemplary views illustrating a method for analyzing an image when a camera on which a laser diode according to an embodiment of the present invention is mounted captures an image from above in the vertical direction;

FIG. 6 is an exemplary view illustrating a distortion generated in the image in accordance with an angle formed between a camera and the ground;

FIGS. 7a and 7b are exemplary views illustrating a method for analyzing an image when a camera on which a laser diode according to an embodiment of the present invention is mounted captures an image with a certain tilt angle;

FIGS. 8a to 8b are exemplary views illustrating an automated calibration method according to an embodiment of the present invention;

FIG. 9 is an exemplary view illustrating a computation process for obtaining a transformation matrix;

FIG. 10 is a flowchart of a camera calibration method using a laser according to an embodiment of the present invention;

FIG. 11 is an exemplary view illustrating the deformation of the laser point in the camera calibration method according to the embodiment of the present invention;

FIG. 12 is an exemplary view illustrating a case where a laser diode is turned by a camera calibration method according to an embodiment of the present invention;

FIG. 13 is a hardware configuration view of a camera calibration apparatus according to an embodiment of the present invention; and

FIGS. 14a to 14b are exemplary views illustrating the process of analyzing images using the camera calibration method according to the embodiment of the present invention.

### DETAILED DESCRIPTION OF THE INVENTION

Hereinafter, the present invention will be described in more detail with reference to the accompanying drawings.

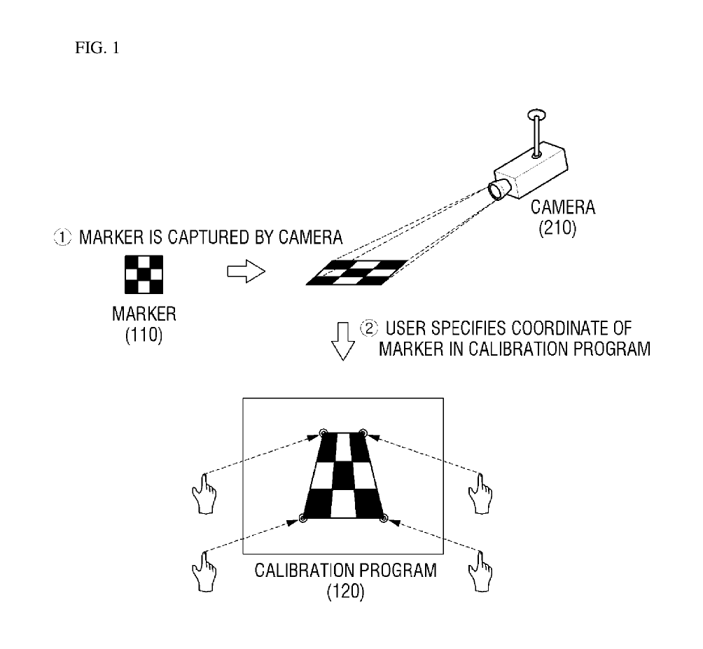

FIG. 1 is an exemplary view illustrating a conventional camera calibration method.

In an image analysis algorithm, it is possible to convert the two-dimensional coordinates of the object projected from the image into the three-dimensional coordinates of the actual world, using a transformation matrix computed through the calibration process. Conceptually and briefly, a process of obtaining a transformation matrix of 2×3 size to transform the 1×2 matrix of [xy] of the image into the 1×3 matrix of [XYZ] in the actual world may be regarded as a calibration. Of course, the size of the actual transformation matrix is not a 2×3 matrix. However, this is only the example given to help the convenience of understanding.

Further, the computation process itself for obtaining the transformation matrix itself is not performed manually. In the process of camera calibration, the transformation matrix is obtained, using Matlab or other various calibration programs. However, input data is necessary in the process. That is, a reference object or a marker with known actual size is captured with a camera, the coordinates of the reference object are obtained from the image, and the coordinate pair obtained by comparing them is used as input data.

Referring to FIG. 1, the process of the conventional camera calibration can be seen. Conventionally, in order to acquire input data of the calibration program 120, a marker 110 was captured with a camera 210. Further, after loading the image including the marker 110 from the calibration program 120, the coordinates of the marker 110 were specified. Conventionally, in order to easily identify the coordinates of the marker 110, as illustrated in FIG. 1, a marker 110 in which black and white intersects with each other in a check pattern was mainly used. Or, in addition to the marker 110 illustrated in FIG. 1, a square or rectangular panel including a specific color was also used as a reference object.

The calibration program 120 analyzes the loaded image to extract the coordinates of each marker 110 or each vertex of the reference object. When comparing information on the size of the actual marker 110 or the reference object with the coordinate information in the image, a transformation matrix can be obtained. However, even when using a marker 110 in which black and white intersect with each other in a check pattern or a reference object having a specific color, in many cases, the coordinates of each vertex may not be correctly extracted. In such a case, as illustrated in the example of FIG. 1, there is a need for a process of manually setting the coordinates of each vertex by a person.

As described in FIG. 1, in the existing process of camera calibration, it was necessary for a person to directly set 1) a process of setting the marker 110 or the reference object in the space in which the camera 210 captures an image, and 2) a process of setting the coordinates of the marker 110 or the reference object with the calibration program 120 for analyzing the captured image. Therefore, when the position of the camera 210 was changed, human intervention was necessary to execute the camera calibration again.

Of course, in the case of a fixed camera that captures an image of a specific space at a specific angle, since it is sufficient to perform only one camera calibration in the process of installing the camera 210, there is little inconvenience. However, when the space captured by the camera 210 may often be changed like the PTZ camera, it is nearly not possible to execute the camera calibration again each time.

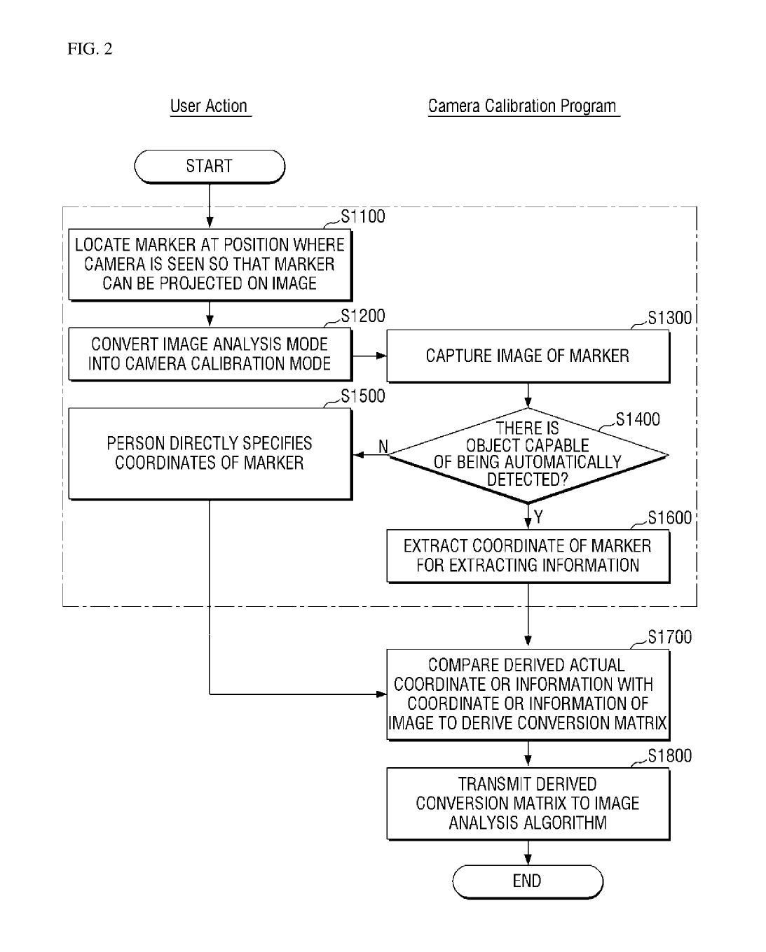

The conventional camera calibration process described in FIG. 1 will be described in the flowchart of FIG. 2, by being divided into a step that requires user intervention, and a step that is automatically executed via the calibration program 120.

FIG. 2 is a flowchart of a conventional camera calibration method.

In FIG. 2, in the conventional camera calibration process, a manually performed step is illustrated in a left User Action region, and an automatically performed step is illustrated in a right Camera Calibration Program region.

First, in order to execute the camera calibration, the marker 110 is located at a place where the camera 210 is seen so that the marker 110 can be projected onto the image (S1100). Next, when the installation of the marker 110 is completed, the image analysis mode is switched into a camera calibration mode in order to execute the camera calibration (S1200). As illustrated in FIG. 2, steps S1100 and S1200 are manually performed steps at which the human intervention is required.

When preparation for executing the camera calibration is completed, the camera 210 captures an image of the space including the marker 110 (S1300). Further, the calibration program 120 loads the captured image, analyzes the loaded image, and checks whether the marker 110 is automatically detected (S1400). If the marker 110 is detected automatically, the coordinates of the marker 110 are extracted in the image (S1600). Steps S1300, S1400, and S1600 are steps that can be automatically executed in the calibration program 120. However, even if the captured image is analyzed, when the marker 110 is not automatically detected, the human intervention is required again (S1500).

Therefore, as illustrated in FIG. 1, conventionally, in order to reduce the manual work, that is, easily detect the marker 110 from the captured image, the marker 110 with black and white intersecting with each other in a check pattern was mainly used. However, in some cases, it may be difficult to detect the marker 110 depending on the image capturing environment. For example, in a camera 210 that captures an image of an outdoor space, there may be case where the space is dark or a case where the main color of the space captured by the camera 210 is similar to the color of the marker 110, which makes it difficult to identify the marker 110 due to a protective color effect.

In such a case, it is necessary for a person to directly manually specify the coordinates of the marker 110 in the camera calibration program 120 (S1500). After the coordinates of the marker 110 is automatically extracted from the camera calibration program 120 (S1600) or after the coordinates of the marker 110 is extracted by a human hand (S1500), the coordinates extracted from the image and the actual coordinates are compared to compute a transformation matrix (S1700).

That is, in fact, a correlation in which an object having an x1 size (meter) is displayed by an x2 size (pixel) in an image captured by the camera is digitized into a transformation matrix. After obtaining the transformation matrix, the conversion matrix is transmitted to the image analysis algorithm, and the camera calibration process is finished (S1800).

In this process, in order to enhance the accuracy of the transformation matrix, the process of capturing the image of the marker 110 may be repeatedly executed. That is, the steps indicated by the dotted line in FIG. 2 may be repeatedly executed. It may be possible to further perform a step in which the marker 110 is installed at another place in the space in which the camera 210 captures an image, the image is captured to extract the coordinates, and the marker 110 is set in another place, and the image is extracted to extract the coordinates. In this way, as more input data is collected, the accuracy of the transformation matrix can be further enhanced. Of course, in this process, it is also necessary to repeat the manual work of a person.

The present invention provides a method and an apparatus capable of automatically executing camera calibration in order to solve the problem requiring the manual work of a person. To this end, it is necessary to be able to solve two kinds of manual works, that is, 1) a step of setting the marker 110, and 2) a step of extracting the coordinates of the marker 110 (if necessary). Therefore, in the present invention, a light source capable of being attached to the camera is used. As the light source, a laser diode is suitable.

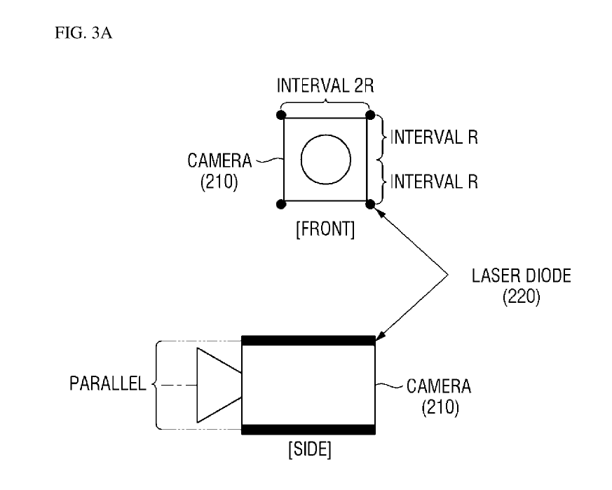

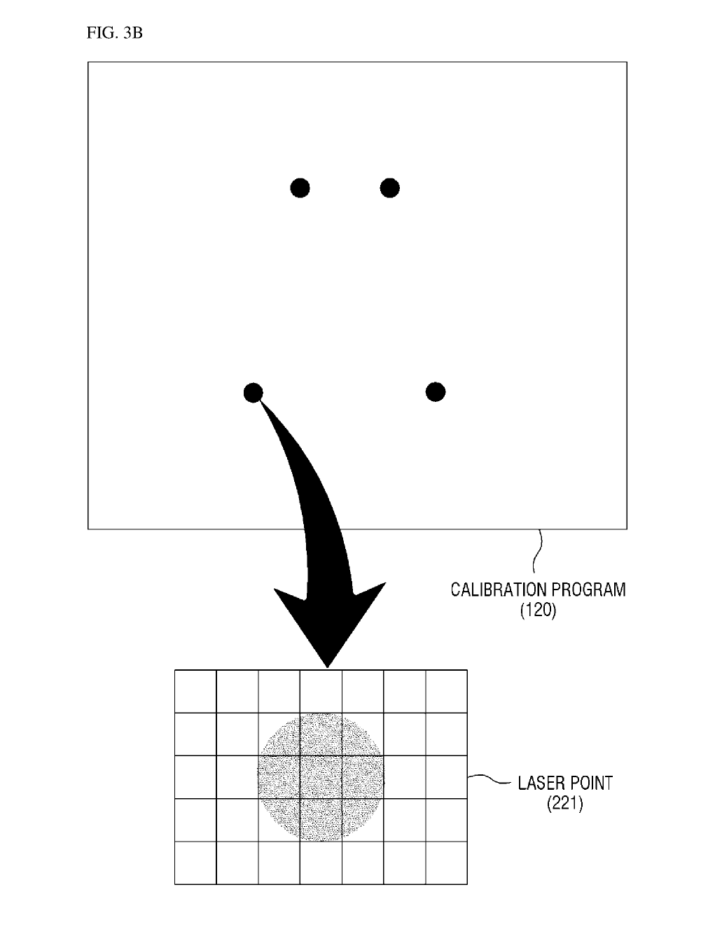

FIG. 3a is a front view and a side view in illustrating a laser diode-mounted camera according to an embodiment of the present invention.

Referring to FIG. 3a, it is possible to understand that four laser diodes 220 are mounted parallel to the optical axis at an interval of 2*R near each vertex of the camera 210.

First, in the front view, the four laser diodes 220 were placed near the apexes of the camera 210. In FIG. 3a, it is assumed that the camera 210 is a square when viewed from the front for the sake of understanding, but the camera 210 does not necessarily need to be a square. The camera 210 may be in the form of a rectangle when viewed from the front. Also, even if the camera 210 is in the form of a rectangle, the laser diode 220 can be sufficiently mounted in the form of square.

Also, although it is assumed that the four laser diodes 220 are also mounted in the form of a square, the four laser diodes 220 does not necessarily need to have the form of a square. The laser diode 220 may be in the form of a rectangle. If the laser diode 220 is mounted on the camera 210 in the form of a rectangle when viewed from the front, it is possible to obtain a transformation matrix, using the horizontal length 2*Rx and the vertical length 2*Ry of the rectangle. Hereinafter, in the present invention, for the sake of better understanding, it is assumed that the laser diode 220 is mounted to the camera 210 in the form of a square when viewed from the front, and the square has a length of one side of 2*R.

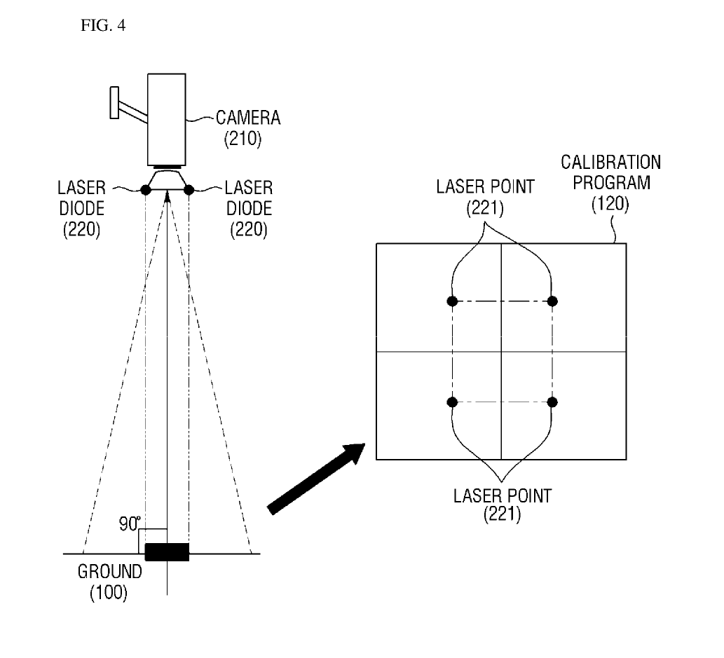

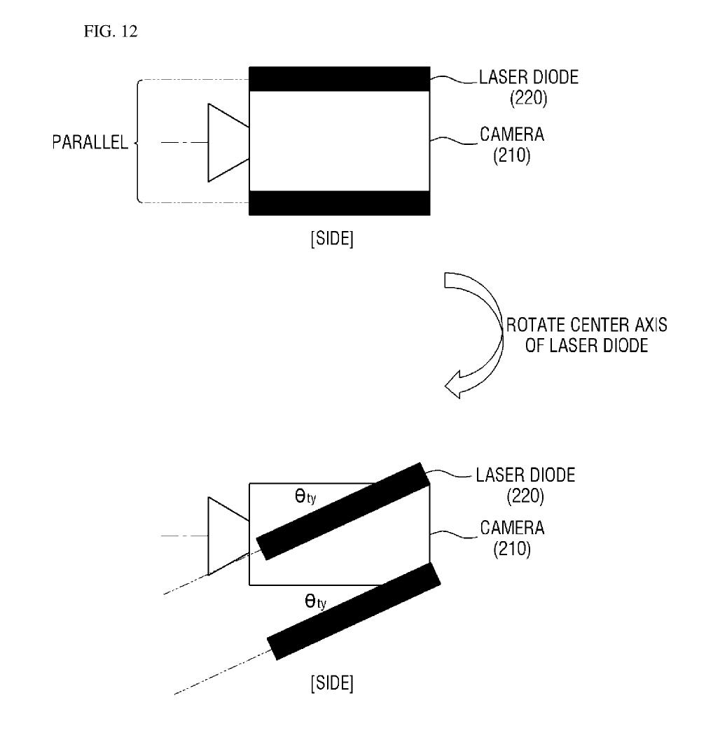

Next, in the side view, it is possible to understand that the laser irradiated by the laser diode 220 is parallel to the optical axis of the camera 210. This is only assumed to be parallel in order to facilitate understanding in FIGS. 4 to 7b to be described below, and the optical axis of the camera 210 is not necessarily parallel to the optical axis of the laser diode 220. A case where the optical axis of the camera 210 and the optical axis of the laser diode 220 are not parallel to each other will be described in FIGS. 12 in more detail.

Finally, although FIG. 3a has been described as having four laser diodes 220, that is, arranged in the form of a square, this is not also limited to the case where the number of laser diodes 220 is always four. In the present invention, since the laser point irradiated from the laser diode 220 is used in replace of the marker 110, the number of laser diodes 220 is sufficient as long as it is possible to form a polygon.

That is, in the present invention, the number of laser diodes 220 may be three or more. When the number of laser diodes 220 is three, triangle markers are used, and in the case of four, rectangular markers are used. In addition to the condition that the number is three or more, there are no other restrictions on the number of laser diodes 220. However, for the sake of convenience of understanding, the description will be continued on the basis of the case where the number of laser diodes 220 is four.

FIG. 3b is an exemplary view illustrating a process of extracting a laser point irradiated by a laser diode in a laser diode-mounted camera according to an embodiment of the present invention.

Referring to FIG. 3b, it is possible to understand that a laser irradiated by four laser diodes 220 mounted on the camera 210 in the form of a square is displayed by four laser points 221 in the calibration program 120. That is, when the laser diode 220 emits laser, an image is formed at a point intersecting with the ground, and when the image is captured and load the image captured by the calibration program 120, as illustrated in FIG. 3b, the image is displayed by four light spots, i.e., the laser point 221.

At this time, although the four laser diodes 220 are arranged in the form of a square, it is possible to understand that the four laser points 221 are displayed on the screen in the form of a trapezoid. Since the laser diode 220 is a square, the laser point 221 on which the image is formed also needs be observed in the form of a square or a rectangle. However, in the process in which three dimensions are expressed by two dimensions, distortion will occur. That is, due to the distortion in which the near object is expressed large and the distant object is expressed small, the laser point 221 is observed on the screen in the form of a trapezoid.

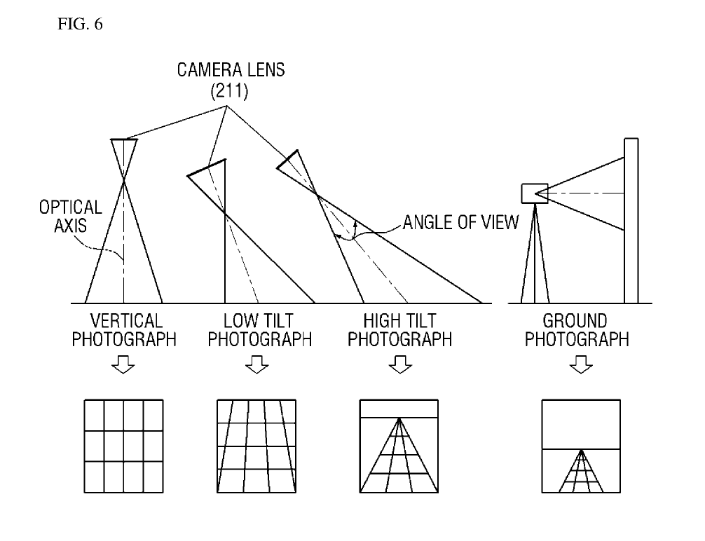

This is closely related to the angle formed between the camera 210 and the ground. If the camera 210 forms a right angle with the ground, the laser point 221 is also displayed in the form of a square. However, when the camera 210 forms a certain angle with the ground, the laser point 221 is displayed in the form of a trapezoid due to distortion. As an obtuse angle formed between the camera 210 and the ground is large, that is, as the angle of the camera 210 is further inclined from an orthogonal state to a horizontal state with respect to the ground, the distortion becomes more severe. When analyzing the degree of the distortion, it is possible to obtain a transformation matrix. This will be explained in FIG. 6 in more detail.

The process of analyzing the image to extract the coordinates of the laser point 221 may be more easily performed as compared to the process of analyzing the image and extracting the coordinates of the marker 110. Referring to FIG. 3b, it is possible to understand that either laser point 221 is enlarged. Each scale means a single pixel. In the case of using the laser diode 220, the coordinates of the laser point 221 can be extracted in consideration of hue, saturation, and value (HSV). That is, the coordinates of the central pixel of the laser point 221 can be extracted through the image analysis.

When using the laser diode 220, since the light source is used as a marker, it is less likely to be affected by the image capturing conditions as compared to the conventional marker 110. That is, even in a dark image capturing environment, a place on which the image of the laser diode 220 is formed is bright. Also, when changing the color of the laser diode 220, the protective color effect can also be prevented. That is, when the image is captured by the camera 210, the laser is changed to the color which can be most contrasted with the color near the central point of the screen on which the image of the laser point 221 is formed, so to speak, a complementary color, and the laser is emitted, it is easier to detect the laser point 221 on the screen.

A camera 210 equipped with a laser diode 220 according to an embodiment of the present invention was described through FIGS. 3a to 3b. A process of obtaining the transformation matrix using the camera 210 equipped with the laser diode 220 will be described below.

FIG. 4 is an exemplary view illustrating a case where a camera, on which a laser diode according to an embodiment of the present invention is mounted, captures an image from above in the vertical direction.

Referring to FIG. 4, it is possible to understand that the camera 210 equipped with the laser diode 220 captures an image of the ground from above in the vertical direction forming an angle of 90° with the ground. At this time, the laser emitted from the laser diode 220 forms an image on the ground in the form of a square. That is, when checking the image captured by the calibration program 120, four laser points 221 are observed in the form of a square as illustrated in FIG. 4. Also, it is possible to understand that the center of the screen coincides with the center of the square, like a concentric circle.

Conversely, in order to check whether the current camera 210 is perpendicular to the ground, it is sufficient to check 1) whether the laser point 221 is formed in the shape of a square on the screen, and 2) whether the center of the screen coincides with the center of the square. As in the example of FIG. 4, in a case where the camera 210 captures an image of the ground in the vertical direction, when the captured image is analyzed, the installed height of the camera 210 may be known.

Unless the four laser diodes 220 are in the case of being mounted in the form of a square, as illustrated in FIG. 3a, for example, when the four laser diodes 220 are disposed in a rectangular shape, in order to check whether the camera 210 is perpendicular to the ground, it is sufficient to check 1) whether the laser point 221 forms a rectangular shape on the screen, and 2) whether the center of the screen coincides with the center of the rectangle. Additionally, 3) it is sufficient to check whether the ratio of the length and width of the rectangle coincides with the ratio of the length and width (Rx:Ry) of the rectangle on which the four laser diodes 220 are installed, on the screen.

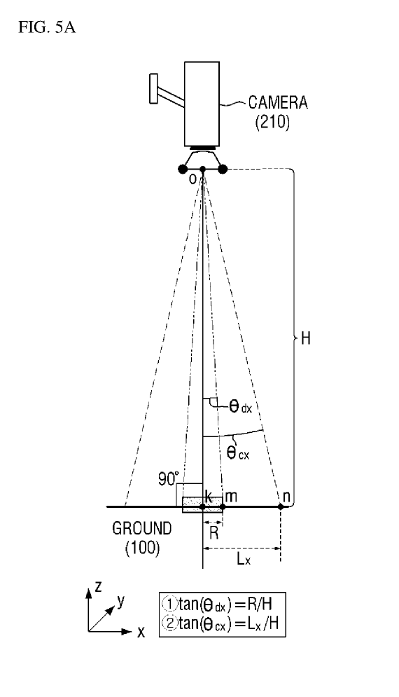

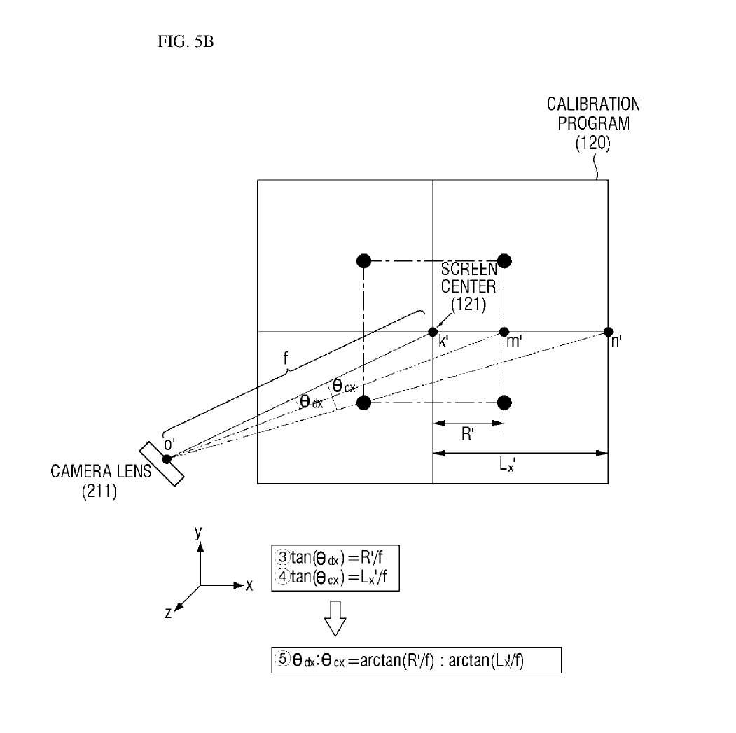

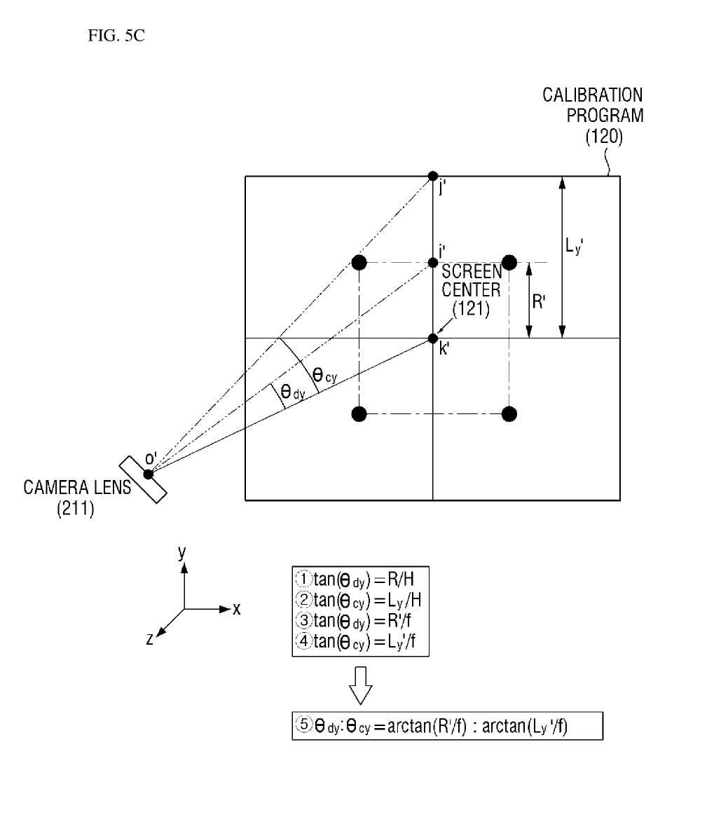

FIGS. 5a to 5c are exemplary views illustrating a method for analyzing an image when a camera, on which a laser diode according to an embodiment of the present invention is mounted, captures an image from above in the vertical direction.

Prior to the explanation of FIG. 5a, since a ground is also a two-dimensional space, how to display the three-dimensional space in FIG. 5a will be first described. Referring to the left lower side of FIG. 5a, it is possible to understand that the coordinate axes of three-dimensional space are illustrated. Assuming that the right direction of the ground is a +x-axis, an upward direction of the ground is +z-axis, and the direction entering the ground is +y-axis, FIG. 5a will be continuously described.

Referring to FIG. 5a, when the camera 210 vertically captures an image of the ground 100 from above in the vertical direction of the height H, it is possible to check a central point o of the camera 210, an intersection point k between an optical axis of the camera 100 and the ground 100, an intersection point m formed between the laser irradiated by the laser diode 220 with the ground, and a limit point n of the ground that can be captured by the camera 210, on the basis of the +x-axis direction.

/mok is an angle formed by the laser point 221 in the +x-axis direction at the center of the camera 210, and ∠mok is indicated by a variable θ_{dx}. ∠nok is an angle formed by a boundary of the ground capable of being captured by the camera 210 at the center of the camera 210 in the +x-axis direction, and ∠nok is indicated by a variable θ_{cx}. At this time, the installed height H of the camera 210, the variable θ_{dx}, and the variable θ_{cx} are values that are not yet known.

A line segment km is ½ of the length of one side in a figure having the form of a square formed on the ground by the laser point 221. Also, since the camera 210 captures an image of the ground from above in the vertical direction, the length of the line segment km becomes R as assumed in FIG. 3a. Finally, a line segment kn is an actual length of the ground capable of being captured by the camera 210 in the +x-axis direction at the center of the camera 210, and this is indicated by a variable Lₓ. Here, the variable Lₓ is a value that is not yet known.

Referring to FIG. 5a, the values of a total of four variables are not known. That is, 1) the height H, 2) the variable θ_{dx}, 3) the variable θ_{cx}, and 4) the variable Lₓ are not known. Instead, the value of R is set by setting the laser diode 220 in the camera 210 beforehand and the value of R is known. That is, R is a constant. Since the values of the four variables are not known, there is a need for a total of four formulas to obtain the values of the four variables. After setting up the four formulas, when solving the simultaneous formulas, the values of each variable can be obtained.

First, two formulas can be obtained in FIG. 5a. This is a formula in which a trigonometric function tangent is applied to ∠mok and ∠nok, and the following two formulas are obtained.

[Formula 1]

tan(θ_{dx})=R/H \textcircled{1}

tan(θ_{cx})=Lₓ/H \textcircled{2}

Since there are only two formulas, there is a further need for two more formulas to obtain the values of the four variables. Insufficient two formulas can be obtained on the screen. That is, FIG. 5a is a formula obtained on a three-dimensional space, and FIG. 5b is a formula obtained on a two-dimensional screen.

Referring to FIG. 5b, it is possible to understand that the image captured in FIG. 5a is displayed on the screen. Similarly, referring to the left lower side of FIG. 5b, it is possible to understand that the coordinate axes of the three dimensional space are illustrated. Assuming that the right direction of the ground is +x-axis, the upward direction of the ground is +y-axis, and the direction coming out to the ground is +z-axis, the description of FIG. 5b will be continued.

Referring to FIG. 5b, the shape of the actual space captured via the camera 210 is formed on a CCD inside the camera 210 through the camera lens 211. An image formed on a CCD (Charge-Coupled Device) inside the camera 210 can be digitized and checked as a two-dimensional image, and can also be checked in the calibration program 120 as in FIG. 5b.

It is possible to check a central point o′ of the camera lens 211, an intersection point k′ between the center axis of the camera lens 211 and the screen, an intersection point m′ in which a square figure formed by the laser point 221 irradiated by the laser diode 220 is displayed on the screen in the +x-axis direction, and a limit point n′ on the screen in the +x-axis direction. This is obtained by k, m, n on the actual space projected on the screen as k′, m′, and n′.

/m′o′k′ is an angle formed by the laser point 221 in the +x-axis direction at the center of the camera lens 211, and has the same value as the variable θ_{dx} of FIG. 5a due to the characteristics of the camera 210. ∠ n′o′k′ is an angle formed by the boundary of the screen in the +x-axis direction at the center of the camera lens 211 and has the same value as the variable θ_{cx} in FIG. 5a due to the characteristics of the camera 210. Since the light entering through the camera lens 211 is refracted to form an image, θ_{dx} and θ_{cx} of FIG. 5a are the same as θ_{dx} and θ_{cx} of FIG. 5b.

A line segment k′m′ is ½ of the length of one side in a square figure formed on the screen by the laser point 221. This value is not yet known value, and will be indicated by a variable R′. A line segment k′n′ is the length of the boundary of the screen in the +x-axis direction at the center of the screen, and will be indicated by a variable Lx′. Since the constant R and the variable Lₓ of FIG. 5a are lengths on the actual space, they have meters as units. Meanwhile, the variable R′ and variable Lₓ′ in FIG. 5b are lengths on the screen, they have pixels as a unit. Thus, there is a difference therebetween.

Finally, a line segment o′k′ is the length formed by the center of the camera lens 211 and the center of the screen, and is referred to as a focal length due to the characteristics of the camera 210. The focal length is a constant value, and is a value that is already known at the time of capturing an image. This will be indicated by f, and f is a constant value.

In FIG. 5b, two formulas can be additionally obtained. This is a formula obtained by applying the trigonometric function tangent to ∠m′o′k′ and ∠n′o′k′, and the following two formulas are obtained.

[Formula 2]

tan(θ_{dx})=R′/f \textcircled{3}

tan(θ_{cx})=L_{x′/f} \textcircled{4}

Here, variables R′ and Lₓ′ are values that are not known, but they can easily be obtained by analyzing the image. This is because the image is analysed to only count the horizontal pixels. In particular, Lₓ′ is a half of the horizontal resolution of the camera 210 and can also be obtained from the specification information of the camera 210. In formula 2, since all of R′, Lₓ′ and f can easily obtain the values, if they are treated as constants, formulas 1 and 2 are summed to obtain a total of four formulas.

When simultaneously solving these formulas, it is possible to obtain the values of 1) height H, 2) variable θ_{dx,} 3) variable θ_{cx}, and 4) variable Lₓ. When using these correlations, it is possible to understand that an object having a length of Lₓ (meter) on the actual space is displayed as the length of Lₓ′ (pixel) on the screen. Conversely, it is also possible to know the actual length x (meter) of the object displayed as x′ (pixel) on the screen. In this way, the process of obtaining the correlation between the three-dimensional space and the two-dimensional screen is the camera calibration.

Referring to FIG. 5b, it is possible to obtain a relational expression between θ_{dx} and θ_{cx}.

[Formula 3]

θ_{dx}:θ_{cx}=arctan(R′/f):arctan(Lₓ′/f) \textcircled{5}

Referring to Formula 3, it is possible to understand that the angle depends on R′ and Lₓ′ on the screen. That is, the angle can be determined depending on the pixels displayed on the screen. When this is unitized, it is possible to obtain the angle per unit pixel. For example, when the camera 210 has a VGA resolution of 640×480, the value of ½ of the horizontal resolution 640 (pixel) is Lₓ′. Further, if θ_{cx} is 40° on the screen at this time, a unit of 0.125° per pixel can be acquired by computing 40°/ 320 pixels.

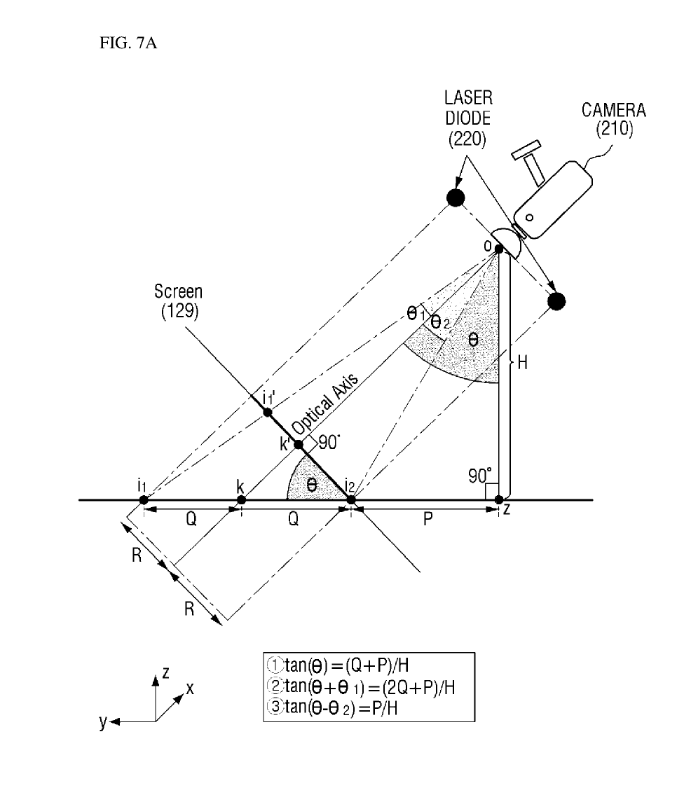

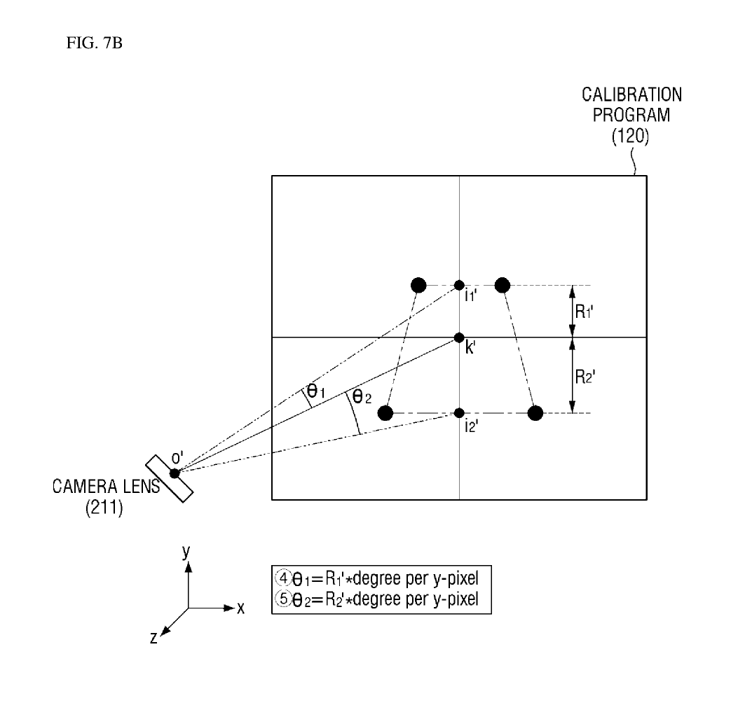

When utilizing the angle per pixel obtained in this manner, as long as the specifications of the camera 210 are not altered, in addition to the vertical image capturing, it is also possible to obtain the angle of the object captured by the camera 210 at a certain angle with the ground. The process of executing the calibration using the angle per pixel will be specifically described in FIGS. 7a to 7b in more detail.

In FIG. 5b, the camera 210 can include an angle of 2*θ_{cx} on the screen. This is commonly called an angle of view. The angle of view is information that is also capable of being obtained through specifications of the camera. In addition to the horizontal angle of view, which is the angle capable of being included on the screen in the horizontal direction by the camera 210, the specification of the camera also has a vertical angle of view which is an angle capable of being included on the screen in the vertical direction. Of course, there is also a diagonal angle of view obtained by combining both of them. That is, the process executed in the x-axis direction in FIGS. 5a and 5b may also be performed in the y-axis direction in the same manner.

Referring to FIG. 5c, it is possible to understand that the process executed in FIG. 5b is executed in the +y-axis direction in the same way. When applying the formulas in FIG. 5c like FIGS. 5a to 5b, a total of four formulas can be obtained.

[Formula 4]

tan(θ_{dy})=R/H \textcircled{1}

tan(θ_{cy})=L_{y/}H \textcircled{2}

tan(θ_{dy})=R′/f \textcircled{3}

tan(θ_{cy})=L_{y}′/f \textcircled{4}

Since it is assumed that the four laser diodes 220 are equally spaced at 2*R, it is possible to obtain a formula in which only R and R′ are the same as in FIGS. 5a to 5b which is in the x-axis direction, and a subscript indicating x-axis direction is replaced with a subscript indicating the y-axis direction. As in the case of FIG. 5b, it is also possible to obtain the angle per vertical pixel.

When simultaneously solving the four formulas of formula 4, it is possible to obtain the values of 1) height H, 2) variable θ_{dy}, 3) variable θ_{cy}, and 4) variable L_{y}. That is, if the laser diode 220 is mounted on the camera 210 at equal intervals and the distance 2*R of the laser diode 220 is known, it is possible to obtain length 2*Lₓ and width 2*L_{y} of the space being captured by the camera 210 using the distance.

Of course, when the angle formed between the camera 210 and the ground is altered, the space between the length 2*Lₓ and the width 2*L_{y} also changes. However, even in this case, when using the characteristics of the camera 210, i.e., 1) the installed height H of the camera 210, 2) the angle per horizontal pixel on the screen, and 3) the angle per vertical pixel, it is possible to map the coordinates on the actual space and the coordinates on the screen in the same way.

FIG. 6 is an exemplary view illustrating the distortion generated in the image according to the angle the camera makes with the ground.

When the camera 210 does not capture the image of the ground 100 in the vertical direction, distortion occurs more severely. The camera 210 and the camera lens 211 intersect with each other at right angles. More precisely, the optical axis of the camera 210 and the camera lens 211 intersect with each other at right angles. FIG. 6 illustrates how the image is distorted in accordance with the angle formed between the camera 210 or the camera lens 211 and the ground 100.

Referring to FIG. 6, the left first diagram illustrates a case where the camera 210 captures an image of the ground 100 in the vertical direction. That is, this is a case where the camera lens 211 is parallel to the ground 100. Distortion at this time is small. When displaying a grid in which the length and width intersect with each other at 90° on the ground 100, it is also possible to check the grid in which the length and width intersect with each other at right angles on the screen.

However, if the camera 210 makes an angle with the ground 100, on the actual ground 100, the grid in which the length and width intersect with each other seems to intersect with each other on the screen at an angle other than 90°. For example, as illustrated in the second example of FIG. 6, when the camera lens 211 makes a low tilt with the ground 100, as illustrated on the image screen beneath it, the grid is displayed in the form of a trapezoid other than a rectangle of 90°.

If the tilt is further inclined, that is, as in the case of the high tilt as the third example of FIG. 6, the horizon appears on the screen and the grid appears in the form of a triangle below the horizon. The vertices of the triangle formed by the grid are points called vanishing point in perspective. If a high tilt photograph or a high tilt image is analysed, since the distortion severely occurs as it is closer to the vanishing point, it is necessary to correct and analyze the distortion.

Comparing the vertical photograph, the low tilt photograph, and the high tilt photograph illustrated in FIG. 6, it is possible to understand that the image in the +y-axis direction becomes more distorted as the tilt is inclined. This is because when the right direction of the drawing is the +y-axis, as the tilt is inclined in the +y-axis direction, the region of the ground 100 distant from the camera 210 is more distorted. It is the effect of “near one is great, and distant one is small” mentioned a couple of times earlier.

If the camera 210 captures an image in parallel with the ground 100, that is, the camera lens 211 captures an image perpendicularly to the paper sheet, a screen is displayed as in the case of the ground photograph in the last example. That is, the horizon is displayed at the center of the screen, the grids are displayed in the form of a sky above horizon and in the form of a triangle below the horizon. Even in such a case, it is possible to map the coordinates on the screen and the coordinates on the actual space through the camera calibration.

To this end, in the present invention, a laser diode 220 mounted on the camera 210 in parallel with the optical axis of the camera 210 is used. That is, a polygonal image made by a laser on the ground of the space captured by the camera 210 is captured to analyze the degree of distortion of the polygon and obtain the angle formed between the camera 210 and the ground, and thereafter, the transformation matrix is computed.

In order to obtain the transformation matrix according to an embodiment of the present invention, an image of polygon provided by the laser diode 220 needs to be formed on the ground 100. When the four laser diodes 220 are used, the image of the form obtained by deformation of the quadrangle is formed on the ground 100. In the case of a vertical direction, a square image is formed as described with reference to FIGS. 5a to 5c, and when the camera 210 is inclined, a trapezoidal image is formed as described in FIG. 6.

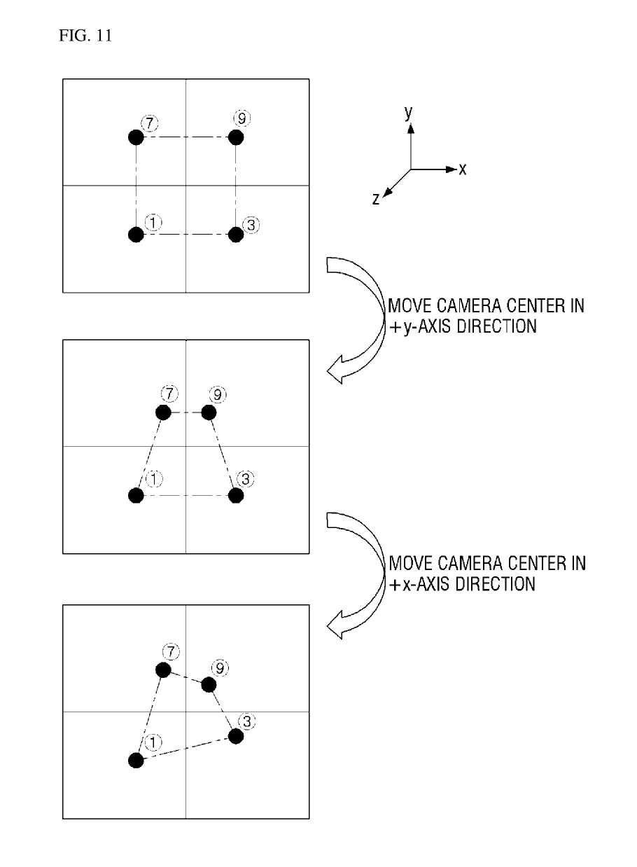

Of course, this is a case where the camera 210 is inclined based on only one of the axes, and if the camera 210 is inclined in both the x-axis direction and the y-axis direction, additional distortion may further occurs in a trapezoid. If the camera 210 is inclined at the same angle both in the x-axis and y-axis, a rectangular image is formed in a form like a diamond in a baseball field. A case where the camera 210 is inclined both in the x-axis and the y-axis will be described in FIG. 11 in more detail.

However, there is a problem. That is, if the angle formed between the camera lens 211 and the ground 100 is large as illustrated in the ground photograph of FIG. 6, there may be a case where the image of the laser diode 220 may not be formed in a region captured by the camera 210. In the case of the ground photography, even if an image may be formed on the ground in the laser diode 220 mounted on the underside of the camera 210 among the four laser diodes 220, since the laser is directly irradiated on the horizon in the laser diode 220 attached to the upper part of the camera 220, the laser point 221 may not be generated.

In such a case, even if the camera 210 is installed parallel to the ground 100 to capture the ground photograph, there is a need to analyze the image after the laser diode 220 is rotated in the direction of the ground 100 to form the image on the ground 100. Or even in a low tilt photograph or a high tilt photograph in which the camera 210 has a certain tilt angle with the ground 100, if there is another object on the ground 100 on which the laser is directly irradiated, it is not possible to obtain a desired trapezoidal figure.

In summary, if an image of the laser is not formed on the ground 100 due to the angle of the camera 210, or if additional distortion occurs due to obstructions even when the image of the laser is formed on the ground 100, it is necessary to rotate the laser diode 220 in a certain direction to obtain a desired trapezoid and analyze the image. The method for analyzing the image by rotating the laser diode 220 will be described in FIG. 12 in more detail.

The phenomenon of distortion of the screen when the camera 210 forms a tilt angle with the ground 100 was considered through FIG. 6. In this way, when the camera 210 forms a tilt angle with the ground 100, a method for analyzing the distorted image will be examined in more detail with reference to FIGS. 7a to 7b.

FIGS. 7a and 7a are exemplary views illustrating a method for analyzing an image when a camera equipped with a laser diode according to an embodiment of the present invention captures an image with a certain tilt angle.

Referring to FIG. 7a, it is possible to see a case where the camera 210 captures an image of the ground 100 with a tilt of the angle θ, unlike the case of FIG. 4. Here, the left lower side of FIG. 7a can be understood to illustrate the coordinate axes of the three dimensional space. The explanation of FIG. 7a will be continued on the assumption that the left direction of the ground is +y-axis, the upward direction of the ground is +z-axis, and the direction entering the ground is +x-axis.

Since the tilt angle θ of the camera 210 is the tilt angle in the +y-axis direction, the distortion of the screen becomes severe toward the +y-axis. That is, even in the same length, since the upper part of the screen is displayed long and the lower part of the screen is displayed short, the rectangle is displayed as a trapezoid in which the lower part is short and the upper part is short on the screen. In FIG. 7a, the laser directly irradiated from the laser diode 220 mounted on the top of the camera 210 is more greatly distorted.

Referring to FIG. 7A, when the camera 210 captures an image of the ground 100 above the height H with an tilt angle θ, it is possible to check the central point o of the camera 210, the intersection point k of the optical axis of the camera 210 and the ground 100, the intersection point i₂ in which the laser irradiated by the laser diode 220 mounted at the lower part of the camera makes with the ground, the intersection point i₁ in which the laser diode 220 mounted at the upper part of the camera makes with the ground, and the intersection point z with the ground below the camera 210 in the vertical direction.

For reference, in FIG. 7a, information on the vertical angle of view of the camera 220 was not separately displayed. The reason is that the information related to the vertical angle of view is already unitized by the angle per horizontal pixel and the angle per vertical pixel, while explaining FIGS. 5a to 5c. The angle per horizontal pixel or the angle per vertical pixel thus united is utilized, when computing the angle of the laser point 221 in FIG. 7b.

∠i₁ ok is the angle formed by the laser point 221 in the +y-axis direction at the center of the camera 210, and ∠i₁ok is indicated by the variable θ₁. ∠i₂ok is the angle formed by the laser point 221 in the −y-axis direction at the center of the camera 210, and ∠i₂ok is indicated by the variable θ₂. Further, ∠zok is the inclined angle of the camera 210, and ∠zok has the same size as ∠ki₂k′. ∠zok is indicated by the variable θ.

Referring to FIG. 7a, the points i₁, i₂, and k of the ground 100 forms a certain tilt angle with the camera lens 211, but when the points are displayed on the screen, the points seem to be projected onto the screen 129 of FIG. 7a. That is, since the image is formed through a CCD provided inside the camera 210 and the CCD inside the camera 210 is parallel to the camera lens 211, in order to examine how the points i₁, i₂, and k are projected onto the screen, a plane perpendicular to the optical axis of the camera 210 needs to be virtually assumed as in the screen 129 in FIG. 7a.

For convenience of understanding, in FIG. 7a, a virtual plane is assumed as a screen 129 and is displayed to pass through point i₂. However, the screen 129 is a virtual assumption of the CCD located inside the camera 210, and does not actually include the point i₂. For convenience of understanding, assuming that the virtual screen 129 includes a point i₂, i₁ of the ground is projected onto the intersection point i₁′ of the line segment oi₁ and the screen 129, and likewise, k of the ground is projected onto the intersection point k′ of the line segment ok and the screen 129. However, since i₂ of the ground will be projected onto i₂ of FIG. 7a, because the screen 129 which is a virtual plane is assumed to include i₂.

Referring to FIG. 7a, since the upper laser diode 220 and the lower laser diode 220 from the center o of the camera 210 are all mounted at equal intervals R, it is possible to understand that the line segments ki₁ and ki₂ also have the same length Q by the ratio of similarity of a triangle. Nevertheless, when the line segments ki₁ and ki₂ are projected onto the image, it is possible to understand that they are projected onto line segments and k′i₁′and k′i₂ which are different lengths. Since the line segment ki₁ is distant from the camera 210, it is displayed as small line segment k′i₁′and since ki₂ is near, it is greatly projected onto the line segment k′i₂.

When the length of line segment zi₂ is set as P, FIG. 7a can obtain three formulas as follows. This the formula obtained by applying the trigonometric function tangent to ∠zok, ∠zoi₁ and zoi ₂, the following three formulas are obtained.

Formula 5

tan(θ)=(Q+P)/H \textcircled{1}

tan(θ+θ₁)=2Q+P)/H \textcircled{2}

tan(θ−θ₂)=P/H \textcircled{3}

Referring to FIG. 7a, the variables are a total five of 1) θ,2) θ₁3)θ,4)Q, and 5)P. The height H of the camera 210 can be treated as a constant since the height H was obtained in advance through FIGS. 5a to 5c. Since there are five unknown values and there are three formulas, two additional formulas are further needed. As in FIG. 5, this can be obtained by analyzing the screen. That is, FIG. 7a is a formula obtained on a three-dimensional space, and FIG. 7b is a formula obtained on a two-dimensional screen.

Referring also to 7b, it is possible to understand that the image captured in FIG. 7a is displayed on the screen. Likewise, the left lower side of FIG. 7b can be understood to illustrate the coordinate axes of the three dimensional space. Even assuming that the right direction of the ground is +x-axis, the upward direction of the ground is +y-axis, and the direction coming out to the ground is +z-axis, the explanation of FIG. 7b will be continued.

Referring to FIG. 7b, the shape of the actual space captured via the camera 210 is included in the CCD inside the camera 210 via the camera lens 211. An image included in the CCD (Charge-Coupled Device) inside the camera 210 can be digitized and checked as a two-dimensional image, and the image can be checked as in FIG. 7b in the calibration program 120.

It is possible to check the central point o′ of the camera lens 211, the intersection point k′ of the center axis of the camera lens 211 with the screen, the intersection point i₁′ in which a trapezoidal figure formed by the laser point 221 irradiated by the laser diode 220 is displayed on the screen in the +y direction, and the intersection point i2′ displayed in the −y direction on the screen, based on the +x-axis direction. This is obtained by projecting k, i₁, and i₂ on the actual space as k′, i₁′, and i₂′ on the screen. Herein, a horizontal angle of view or a vertical angle of view were not separately displayed. This is because they have already been united into an angle per horizontal pixel and an angle per vertical pixel through FIGS. 5a to 5c.

∠i₁′o′k′ is the angle formed by the laser point 221 in the +y-axis direction at the center of the camera lens 211, and the same value as the variable θ₁ of FIG. 7a due to the characteristics of the camera 210. ∠i₂′o′k′is the angle formed by the boundary of the screen in the −y-axis direction at the center of the camera lens 211, and has the same value as the variable θ₂ in FIG. 7a due to the characteristics of the camera 210. Since the light entering through the camera lens 211 is refracted to form an image, the angles θ₁ and θ₂ of FIG. 7a are the same as the angles θ₁ and θ₂ of FIG. 7b.

Line segment k′i₁′ is the height from the center of the screen to the upper short side in a trapezoidal shape formed by the laser point 221 on the screen. This value is a not yet known value, and will be indicated as a variable R₁′. Line segment k′i₂′ is the height from the center of the screen to the lower long side in a trapezoidal shape formed on the screen by the laser point 221. This value is a not yet known value, and will be expressed by a variable R₂. Since the variables R₁ and R₂ of FIG. 7a are lengths on the actual space, they have meters as a unit, whereas the variables R₁′ and R₂′ of FIG. 7b are lengths on the screen, they have pixels as a unit.

Finally, the line segment o′k′ is the length formed by the center of the camera lens 211 and the center of the screen, and this is called a focal length due to the characteristics of the camera 210. The focal length is a constant value, and is a value that has been already known at the time of capturing an image. This value will be expressed by f, and f is a constant value.

In FIG. 7b, two formulas can be additionally obtained. They are θ₁ and θ₂ which are the angles of /i₁′o′k′ and /i₂′o′k′. Since the angle per vertical pixel of the screen was obtained in FIGS. 5a to 5c, it is possible to compute the angles expressed by R1′ and R2′ on the screen in reverse.

[Formula 6]

θ₁=R₁′*degree per y-pixel \textcircled{4}

θ₂=R₂′*degree per y-pixel \textcircled{5}

The angles θ₁ and θ₂ can be obtained by using the lengths R₁′ and R₂′ which are the extents of distortion of the trapezoidal shape on the screen. When substituting angles θ₁ and θ₂ thus obtained into the three formulas of formula 5, the tilt angle θ, the length Q and the length P of the camera 210 can be obtained. Thus, it is possible to check how long length (meter) the length (pixel) displayed on the screen has on the actual space. This will be expressed by more concrete formulas as follows.

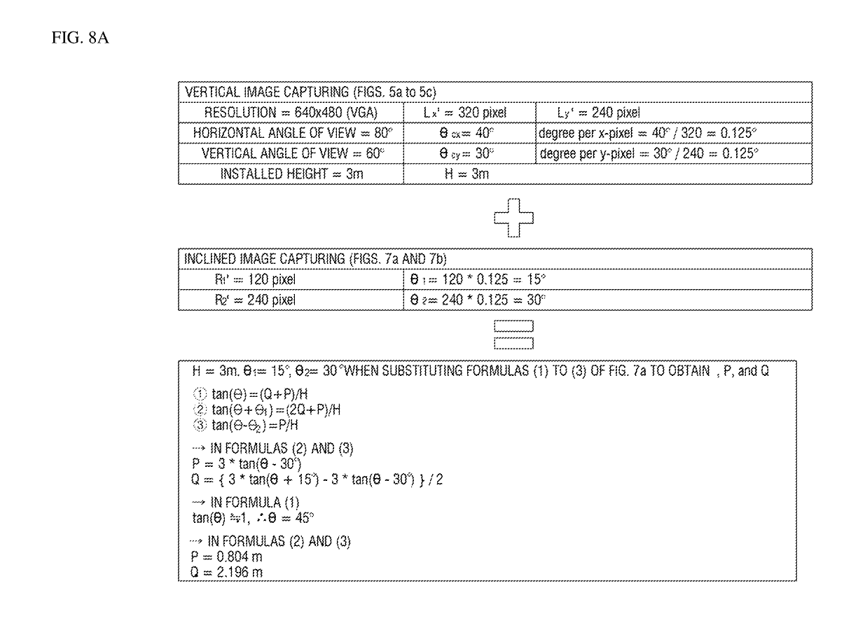

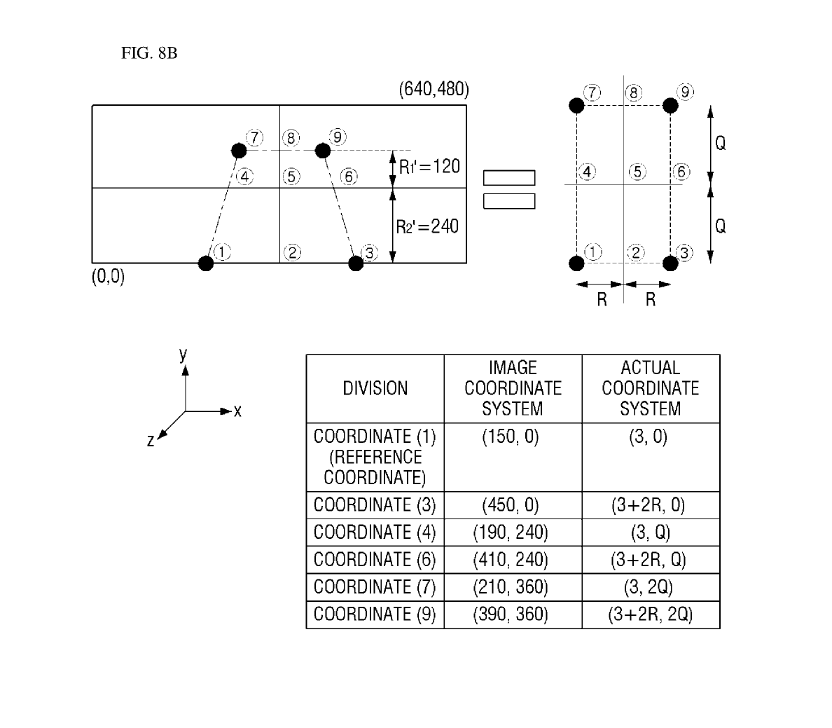

FIGS. 8a to 8b are exemplary views illustrating an automated calibration method according to an embodiment of the present invention.

Referring to FIG. 8a, it is possible to understand that the processes described in FIGS. 5a to 5c and FIGS. 7a to 7b are computed with concrete numerical values. First, assuming that the camera 210 has a resolution of 640×480 (VGA), it is possible to understand that Lₓ′ and L_{y}′ as a half of the resolution are 320 pixels and 240 pixels from the camera specification. Also, from the specifications of the camera, it is understood that the horizontal angle of view is 80° and the vertical angle of view is 60°. Then, similarly, it is possible to check that θ_{cx}=40° and θ_{cy}=30° which are half of the horizontal angle of view and the vertical angle of view. Finally, it is possible to check that the installed height of the camera 210 is 3 m by the formula derived from FIGS. 5a to 5c.

Of course, even if camera specification information such as resolution, horizontal angle of field and vertical angle of view is not used, when the formulas derived from the focal length f and the formulas derived from FIGS. 5a and 5b are used, the values of Lₓ′ and L_{y}′, θ_{cx} and θ_{cy} can be obtained. When analyzing the image taken in the vertical direction by the camera 210 in this manner, preparation for performing the calibration is finished, using the installed height of H=3 m of the camera 210, the angle per horizontal pixel of 0.125°, and the angle per vertical pixel of 0.125°. If the installed height of the camera, the angle per horizontal pixel, and the angle per vertical pixel are known in advance, the processes of FIGS. 5a to 5c may be omitted.

If the camera has the PTZ function and the position of the camera 210 is adjusted, it is possible to obtain the correlation between the two-dimensional coordinates on the screen and the three-dimensional coordinates on the actual space, using the installed height H of the camera 210, the angle per horizontal pixel and the angle per vertical pixel which are previously obtained. Referring to FIG. 8a as a specific example, when the camera 210 is adjusted to have an tilt angle θ in a certain +y-axis direction with the ground 100, it is possible to obtain information in which the height R₁′ of the upper portion of the trapezoid is 120 pixels at the center of the screen, and the height R₂′ of the lower portion of trapezoid is 240 pixels through analysis of the screen.

It is possible to check angles θ₁=15° and θ₂=30°, by multiplying the values obtained by measuring the extent to which the laser point 221 directly irradiated by the laser diode 220 is trapezoidally distorted on the screen, using R₁′ and R₂′, by the angle per vertical pixel as the movement in the +y-axis direction. For reference, when the camera is rotated in the +y-axis direction, since θ₁ is the angle formed by the laser point 221 on the distant side, and θ₂ is the angle formed by the laser point 221 on the near side, there is a relation of θ₁<θ₂.

When substituting H=3 m, θ₁=15°, and θ₂=30° thus obtained into the formulas \textcircled{1} to \textcircled{3} of FIG. 7a, the remaining values of θ, P, and Q can be obtained. Of course, in the case of a PTZ camera, it is possible to obtain the rotation angle θ with camera specification information via the control unit of the camera. Also referring to FIG. 8a, it is possible to check by computation that the rotation angle θ is 45°, the P value at that time is 0.804 m, and the Q value is 2.196 m.

After all the values of the variables are obtained using the image analysis, it is necessary to obtain a coordinate pair for obtaining the transformation matrix. That is, on the screen, it is necessary to obtain whether 2D coordinates of specific (x1, y1) correspond to 3D coordinates of specific (X1, Y1, Z1) on the screen by the coordinates pair. When using a conventional calibration module, by utilizing a coordinate pair thus obtained as input data, it is possible to obtain a transformation matrix.

That is, the complicated computation process itself that computes the transformation matrix using the coordinate pair as an input uses the conventional method as it is. An object of the present invention is to provide a marker using the laser diode 220 so as to be able to automatically easily obtain a coordinate pair used for the input and a formula for deriving a coordinate pair from the marker.

Referring to FIG. 8b, it is possible to see a correlation between the rectangular figure formed on the ground 100 by the laser diode 220 and the trapezoidal figure formed on the screen by the laser point 221. First, referring to the coordinates on the right actual space, since the camera 210 captures an image of the ground 100 at a certain tilt angle from the ground 100, the laser diode 220 mounted on the camera 210 in the form of a square directly irradiates the laser onto the ground in a rectangular shape. This is as if the shadows are getting longer as they get away from the street lights.

When examining the coordinates on the screen on the left side captured with the camera 210, it is possible to understand that the upper sides \textcircled{7}, \textcircled{8}, \textcircled{9} of the rectangle on the distant side is displayed short on the screen, and the lower sides \textcircled{1}, \textcircled{2}, \textcircled{3} of the rectangle on the near side is displayed long. A rectangle on the actual space was transformed into a trapezoid on the screen, but the lengths of the corresponding sides are the same. That is, the interval between \textcircled{1}-\textcircled{2}, \textcircled{2}-\textcircled{3}, \textcircled{4}-\textcircled{5}, \textcircled{5}-\textcircled{6}, \textcircled{7}-\textcircled{8}, and \textcircled{8}-\textcircled{9} on the actual space corresponds to R, and the interval between \textcircled{1}-\textcircled{4}, \textcircled{4}-\textcircled{7}, \textcircled{2}-\textcircled{5}, \textcircled{5},\textcircled{8}, \textcircled{3}-\textcircled{6}, and \textcircled{6}-\textcircled{9} corresponds to Q.

Since the pixels of R1′ and R2 are known in FIG. 8a, it is possible to obtain the correspondence between the 2D image coordinate system on the screen of FIG. 8b and the 3D actual coordinate system on the actual space, using the pixels. That is, when the left lower side of the image is displayed as coordinates (0, 0) and the right upper side is displayed as resolution (640, 480), the coordinates are obtained as in table 8 in view of the pixels of R₁′ and R₂′ being 120 pixels and 240 pixel.

When the coordinate \textcircled{1} is used as a reference coordinate, in the image coordinate system, \textcircled{1} is (150, 0) and has the value of (3, 0) in the actual coordinate system. However, since the Z-axis 0 has the value of 0 in the actual coordinate system, it is omitted. Likewise, the coordinate \textcircled{3} is (450, 0) and has the value of (3+R2, 0) in the actual coordinate system. In this way, it is possible to compare the image coordinate system and the actual coordinate system with respect to all nine coordinates based on the reference coordinate \textcircled{1}.

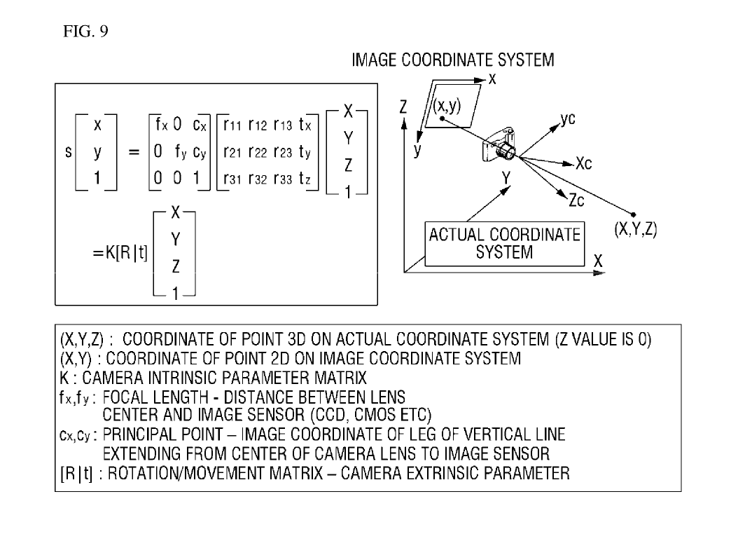

When using a coordinate pair obtained by comparing the image coordinate system and the actual coordinate system in this way, it is possible to obtain a transformation matrix. The process of actually obtaining a transformation matrix with a coordinate pair will be described with reference to FIG. 9.

FIG. 9 is an exemplary view illustrating a computation process for obtaining a transformation matrix.

The computation process for obtaining the transformation matrix exemplified in FIG. 9 is the same as the conventional computation process. The computation of obtaining the transformation matrix using the coordinate pair can be performed, using the solvePnP function of opencv. At this time, the number of required coordinate pair is at least four. Since a total of nine coordinate pair can be obtained in FIG. 8b, it is possible to obtain the transformation matrix using this.

Referring to FIG. 9, the matrix of rotation/movement of [Rlt] is the transformation matrix that we want to obtain. The method for obtaining the matrix is summarized as follows. 1) fₓ, f_{y}, cₓ, and c_{y} are the focal length and the principal points that are the values already known through specifications of the camera.

Next, 2) the 3D coordinates on the actual space of the four laser points 221 and the 2D coordinates on the image are compared with each other through the laser diode 220. To this end, the tilt angle θ at which the camera 210 is installed is obtained, and the corresponding coordinate pair is obtained as in the example of FIGS. 8a to 8b.

Next, 3) the matched coordinate pair is substituted into the existing formula to obtain the rotation/transformation matrix [Rlt]. By using this, it is possible to obtain the actual size by utilizing the pixel information in the image.

As described above, when using the present invention, it is possible to easily obtain minimum four or more coordinate pairs required as input for obtaining a rotation/transformation matrix, that is, a transformation matrix, using a laser diode.

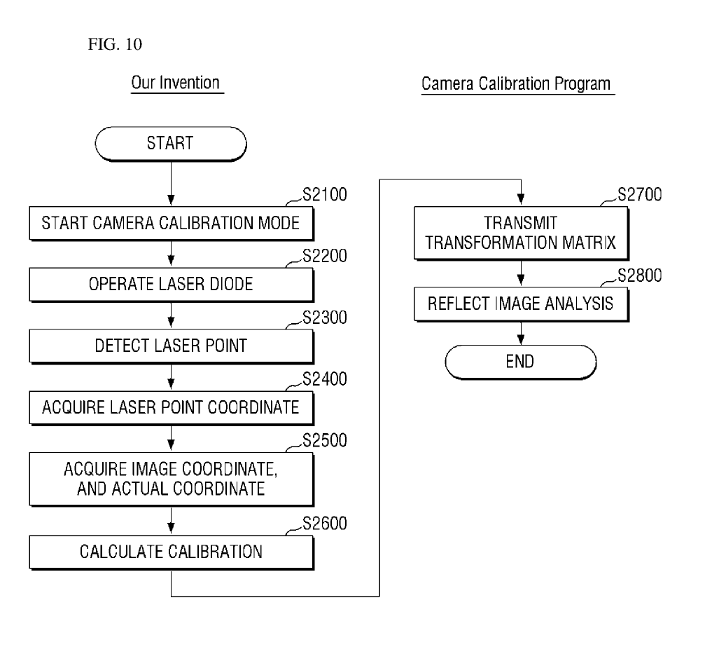

FIG. 10 is a flowchart of a camera calibration method using a laser according to an embodiment of the present invention.

Comparing FIG. 2 and FIG. 10 illustrating a conventional camera calibration method with a flow chart, in the case of the present invention, it is possible to understand that the process of installing the marker 110 or the reference object, or the process of setting the coordinates in the camera calibration program 120 is omitted. That is, there is an effect capable of automatically performing the camera calibration again even if the position of the camera 210 is changed like a PTZ camera, by automating the process requiring a manual work.

According to the present invention, the camera calibration can be performed periodically or when movement of the camera position is detected. When the camera 210 automatically starts the camera calibration mode (S2100), the laser diode 220 is operated (S2200). That is, when forming the laser point 221 by directly irradiating the laser from the laser diode 220 to a site where the camera 210 captures an image, the laser point is analysed to acquire the coordinates of the laser point 221 (S2400).

Based on the coordinates of the laser point 221, when the tilt of the camera 210 is obtained and at least four coordinate pairs obtained by comparing the 2D coordinates of the image and the actual 3D coordinates are obtained (S2500) through the tilt, the input data for performing the camera calibration are completely prepared. After that, through a calibration process (S2600), a transformation matrix is obtained (S2700), and the image can be analyzed using the transformation matrix (S2800).

As described with reference to FIG. 10, when using the present invention, it is possible to automatically obtain the input data for executing calibration, that is, at least four or more coordinate pairs without manual work. This makes it possible to always have the latest conversion matrix information, regardless of the position or state of the camera. This makes it possible to further improve the efficiency of image analysis.

Until now, the automated calibration method using the laser of the present invention has been described through FIGS. 3a to 10. For the sake of simplicity of understanding, only the case where the camera 210 is inclined on the basis of only one axis of the x-axis or the y-axis has been described, but in some cases, the image can be captured in the state in which both of the x-axis and y-axis are inclined. In this case, the description as to how the laser point 221 formed by the laser diode 220 changes will be made referring to FIG. 11.

FIG. 11 is an exemplary view illustrating the deformation of the laser point in the camera calibration method according to the embodiment of the present invention.

Referring to FIG. 11, when the camera 210 directly irradiates the laser in the vertical direction, the rectangular figure formed on the laser point 221 is a square, and there is no distortion yet at this time. Here, when the camera is inclined in the +y-axis direction, distortion occurs in the image in the +y-axis direction. In other words, the coordinates \textcircled{7} and \textcircled{8} located in the +y-axis direction are distorted, and appear to be closer than the original length. That is, the laser point 221 is observed in the second trapezoidal shape.

Here, when the camera is tilted in the +x-axis direction with the same tilt as the +y-axis direction, distortion will occur in the +x-axis direction. That is to say, distortion occurs obliquely. When the figure is deformed in this way, the laser point 221 is observed in the same way as the diamond of the baseball field as displayed last. Of course, even if the laser point 221 is observed in this manner, by obtaining the tilt of the camera in the +x-axis direction and the tilt of the camera in the +y-axis direction, and by comparing the coordinates on the image coordinate system of each laser point 221 with the coordinates on the coordinate system, a transformation matrix can be obtained.

FIG. 12 is an exemplary view illustrating a case where a laser diode is rotated in a camera calibration method according to an embodiment of the present invention.

For convenience of understanding, the description has been made on the basis of the case where the optical axis of the camera 210 and the optical axis of the laser diode 220 are parallel to each other as illustrated in the side view illustrated in FIG. 12 for convenience of understanding. However, in some cases, the optical axis of the laser diode 220 may have a tilt that is different from that of the camera 210.

In the present invention, the laser point 221 is detected by directly irradiating the laser to the ground 100 of the region where the camera 210 captures an image in the laser diode 220 mounted on the camera 210. However, if there are other objects on the ground 100, the laser point 221 is deformed unlike intended case. For example, case where the camera 210 is inclined in the +y-axis direction, but the laser point 221 are detected on the image by a shape other than a trapezoid shape, may be considered as a case where there is an object in the area or the ground of the area is not flat.

In such a case, by adjusting only the laser diode 220 differently from the inclined angle of the camera 210, it is possible to adjust the position the image on which the laser point 221 is formed on the ground 100. As a result, after adjusting the laser diode 220 so that a trapezoid which is an originally intended rectangular shape is observed, by further reflecting the tilt angle θ_{ty} of the laser diode 220, the coordinate pair can be obtained.

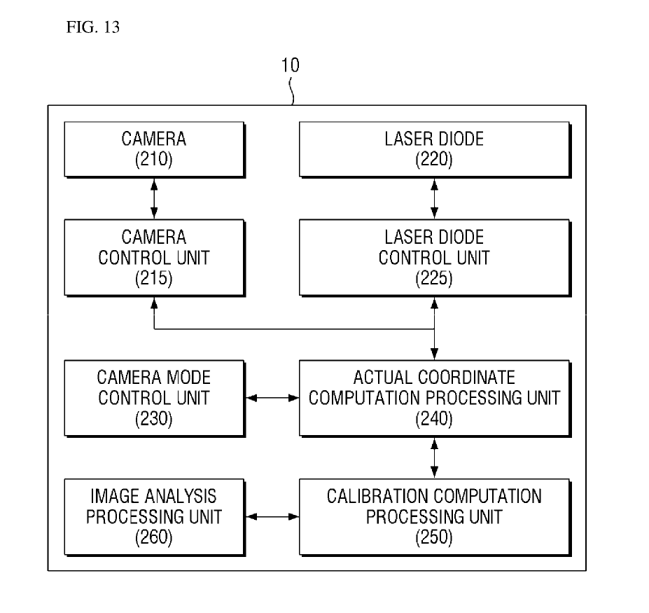

FIG. 13 is a hardware configuration diagram of a camera calibration apparatus according to an embodiment of the present invention.

Referring also to FIG. 13, the camera calibration apparatus 10 of the present invention can perform the camera calibration, by utilizing the camera 210 and the laser diode 220 attached to the camera, even without a marker 110 or a reference object. When the camera 210 is rotated to an area required to capture an image through the camera control unit 215, the laser diode control unit 225 directly irradiates the laser to the ground 100 of the area to form the laser point 221.

The camera mode control unit 230 changes the state of the camera 210 to the calibration mode, and captures an image of the laser point 221 when formed on the ground 100. The actual coordinate computation processing unit 240 compares the 2D coordinates on the screen of the laser point 221 with the actual 3D coordinates through an image analysis, finds a coordinate pair, and adds the coordinate pair to the calibration computation processing unit 250 as input data.

The calibration computation processing unit 250 obtains a conversion matrix with input of at least four or more coordinate pairs as an input and transmits the conversion matrix to the image processing unit 260 to utilize the conversion matrix for images requiring analysis. If the position of the camera 210 is changed, calibration can be automatically performed again through the above process and the latest conversion matrix can be secured.

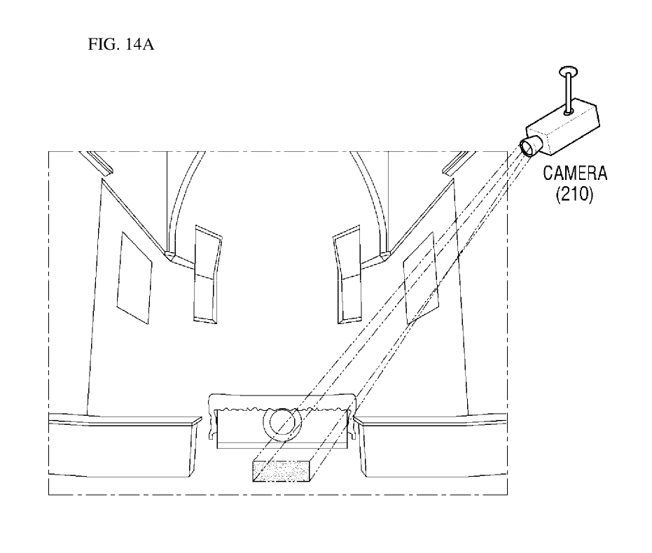

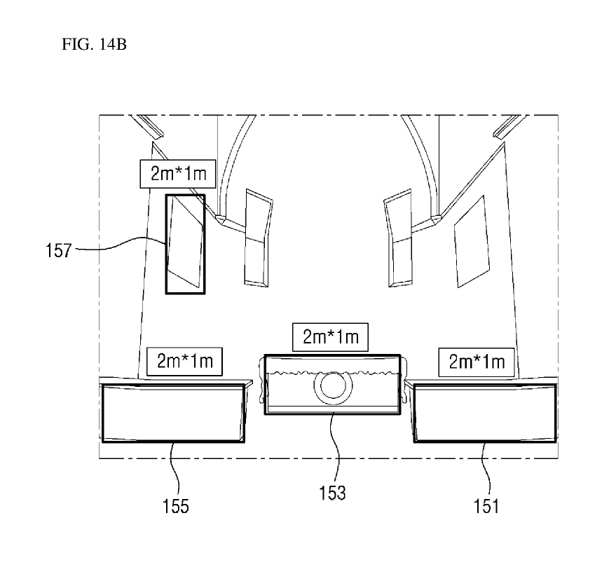

FIGS. 14a to 14b are exemplary views illustrating the process of analyzing images using the camera calibration method according to the embodiment of the present invention.

When actually applying the automated calibration method described above, it can be applied in situations as in FIGS. 14a to 14b. For example, a camera 210 is installed to capture the image of the interior of the cathedral. At this time, when the camera 210 directly irradiates the laser to the ground 100 and the image of the laser point 221 is formed, a transformation matrix can be obtained by analyzing the image.

Then, by analyzing the image captured by the camera, it is possible to obtain information in which a central altar 153 has a length of 2 m and a height of 1 m Likewise, it is possible to obtain information in which a left altar 155 and a right altar 151 also have a length of 2 meter and a height of 1 m. Also, it is possible to understand that the picture 157 hanging on the left wall surface has a length of 2 m and a width of 1 m. By ensuring the transformation matrix in this way, it is possible to acquire size information on all actual objects appearing on the screen in the actual space.

As a result, compared to the conventional calibration method, it is possible to reduce the time and the number of personnel consumed for installing the actual measurement device. Also, calibration is also possible in spaces difficult for people to reach, such as a high position, a deep position, and a dangerous place. Such an automated calibration can also be applied to a movable camera in addition to a fixed camera. For example, by inputting disaster relief and navigation equipment at a disaster site, and by acquiring calibration information on image analysis in actual time, information on distance and size can be obtained.

Even if the sizes of the existing objects are not actually measured in the indoor space, the sizes can easily be found using image analysis. When using this, since it is possible to know the size of the conventional objects placed in the indoor space, it may be used in interior design in conjunction with the design tool.

However, the effects of the inventive concept are not restricted to the one set forth herein. The above and other effects of the inventive concept will become more apparent to one of daily skill in the art to which the inventive concept pertains by referencing the claims.

What is claimed is:

1. An apparatus for performing calibration on a camera using a light source, the apparatus comprising:
n-light sources, n being three or more, which can be mounted on the camera;
at least one processor configured to perform the calibration by implementing:
an actual coordinate computation processing unit which receives data of an image of an n-sided polygon made up of n-light spots formed on an image pickup surface, and analyzes a degree of distortion on an n-sided screen to obtain at least n coordinate pairs obtained by matching coordinates on the n-sided screen and coordinates on an actual space; and
a calibration computation processing unit which receives the at least n coordinate pairs to convert a two-dimensional coordinate on the n-sided screen into a three-dimensional coordinate on the actual space.

2. The apparatus of claim 1, wherein the n is four, and
the n-light sources are mounted in a form of a square so to have an optical axis parallel to an optical axis of the camera.

3. The apparatus of claim 2, wherein, when the n-sided polygon is a rectangle on the image pickup surface and is a trapezoid on the n-sided screen, the actual coordinate computation processing unit determines that the camera is inclined with respect to the image pickup surface, and multiplies a length R₁′ from a center of the n-sided screen to an upper side of the trapezoid and a length R₂′ from the center of the n-sided screen to a lower side of the trapezoid by an angle per pixel of the camera to obtain an angle θ at which the camera is inclined in a vertical direction with respect to the image pickup surface, and wherein the length R₁′ and the length R₂′ are pixel lengths.

4. The apparatus of claim 3, wherein the angle per pixel of the camera comprises at least one from among an angle per horizontal pixel obtained by dividing a horizontal angle of view of the camera by a horizontal resolution of the camera, and an angle per vertical pixel obtained by dividing a vertical angle of view of the camera by a vertical resolution of the camera.

5. The apparatus of claim 3, wherein the actual coordinate computation processing unit obtains the angle θ by simultaneously setting tan (θ)=(Q+P)/H and tan (θ+θ1)=(2Q+P)/H and tan (θ−θ2)=P/H,
wherein, θ1 is an angle from a center of the rectangle to a center of an upper side, θ2 is an angle from the center of the rectangle to a center of a lower side, Q is a half of a length of a long side of the rectangle, P is a distance on the image pickup surface from the lower side of the rectangle to a vertically lower point of the camera, and H is a height at which the camera is installed.

6. The apparatus of claim 3, wherein the actual coordinate computation processing unit obtains the at least n coordinate pairs by matching the coordinates on the n-sided screen of four light spots forming the n-sided polygon and the coordinates on an image pickup plane in a one-to-one correspondence.

7. The apparatus of claim 2, wherein the actual coordinate computation processing unit obtains a height H at which the camera is installed and an angle per pixel of the camera, when the n-sided polygon is a square on the image pickup surface and is a square on the n-sided screen, by determining the camera to be in a vertical direction with respect to the image pickup surface, and by utilizing a length R′ from a center of the n-sided screen to one side of the square and a half L′ of a resolution of the camera, and wherein the length R′ and the half L′ are pixel lengths.

8. The apparatus of claim 2, wherein the at least one processor is further configured to implement:
a camera mode control unit wherein, when the n-sided polygon is not a trapezoid on the n-sided screen, determines that there is an obstacle on the image pickup surface or the image pickup surface is not flat, and determines that the calibration is not performed.

9. The apparatus of claim 8, wherein the at least one processor is further configured to implement:
a light source control unit which equally rotates four light sources by θₜ to correct the n-sided polygon so as to be displayed in a trapezoidal shape on the n-sided screen, when the camera mode control unit determines that the calibration is not being executed.

10. The apparatus of claim 9, wherein the camera mode control unit determines again to perform the calibration when the light source control unit corrects a rectangle to be displayed as the trapezoidal shape on the n-sided screen, and
the actual coordinate computation processing unit analyzes the degree of distortion on the n-sided screen of the n-sided polygon, further using a rotation angle θt of a laser diode, and obtains the at least n coordinate pairs.

11. The apparatus of claim 1, wherein the at least one processor is further configured to implement:
a camera mode control unit which periodically repeats the calibration in accordance with a preset period.

12. The apparatus of claim 1, wherein the at least one processor is further configured to implement:
a light source control unit which analyzes a color of the image pickup surface to change colors of the n-light sources to colors that are complementary colors of the color of the image pickup surface.

13. A non-transitory machine readable medium storing a program which when executed by at least one processor provides instructions for calibrating a camera, the instructions comprising:
control a light emitting unit including n-light sources and being mounted to the camera, to project n-light spots on an image pickup surface;
capturing an image of an n-sided polygon formed by the n-light spots projected on the image pickup surface;
determining a degree of distortion on an n-sided screen to obtain at least n coordinate pairs obtained by matching coordinates on the n-sided screen and coordinates on an actual space; and
converting a two-dimensional coordinate on the n-sided screen into a three-dimensional coordinate on the actual space using the at least n coordinate pairs.
